(19) United States
(12) Patent Application Publication
(10) Pub. No.: US 2025/0341689 A1
(43) Pub. Date: Nov. 6, 2025

(54) OPTICAL MODULE WITH NON-LINEAR HEAT DISSIPATION FIN

(71) Applicant: Prime World International Holdings Ltd., New Taipei City (TW)

(72) Inventors: Che-Shou YEH, New Taipei City (TW); Ming-You LAI, New Taipei City (TW); Hsuan-Chen SHIU, New Taipei City (TW); Yu CHEN, New Taipei City (TW); Yi-Ju WANG, New Taipei City (TW); Ling-An KUNG, New Taipei City (TW)

(21) Appl. No.: 18/751,998

(22) Filed: Jun. 24, 2024

(30) Foreign Application Priority Data
May 6, 2024 (TW) 113116621

(51) Int. Cl. G02B 6/42

(52) U.S. Cl. CPC G02B 6/4269; G02B 6/4278; G02B 6/4284

(57) ABSTRACT

The present disclosure provides an optical module, including a housing and a heat sink. The heat sink is located on an outer surface of the housing. The heat sink includes a plurality of non-linear fins. Each of the plurality of non-linear fins extends in a longitudinal direction of the housing. The plurality of non-linear fins are arranged along a transverse direction of the housing. Adjacent two of the plurality of non-linear fins together form a flow channel. Adjacent two of the plurality of non-linear fins are substantially linearly symmetrical about a longitudinal axis of the housing.

### CROSS-REFERENCE TO RELATED APPLICATIONS

This non-provisional application claims priority under 35 U.S.C. § 119(a) on Patent Application No(s). 113116621 filed in Taiwan, ROC on May 6, 2024, the entire contents of which are hereby incorporated by reference.

### BACKGROUND

### Technical Field

The present disclosure relates to an optical module, particularly to an optical module with non-linear heat dissipation fin.

### Related Art

Optical modules can transmit and/or receive optical signals for various applications including, but not limited to, internet data center, Cable TV, and fiber to the home (FTTH). Using optical modules for transmission can provide higher transmission rates and signal bandwidth over longer transmission distances. In order to enhance the compatibility of optical internetworking products all over the world and to reduce the burden of maintenance, organizations such as Multi-Source Agreement (MSA), Institute of Electrical and Electronic Engineers (IEEE), and Optical Internetworking Forum (OIF) have developed several form factors adapted to different signal transmission rates. These form factors include, but not limited to, XFP, SFP, QSFP (Quad Small Form Factor Pluggable), QSFP-DD (Double Density), OSFP (Octal Small Form Factor Pluggable), and CPO (Co-Packaged Optics).

However, conventional optical modules still present some problems, such as optical efficiency (power), space management, thermal management, insertion loss and manufacturing yield.

### SUMMARY

According to one embodiment of the present disclosure, an optical module includes a housing and a heat sink. The heat sink is located on an outer surface of the housing. The heat sink includes a plurality of non-linear fins. Each of the plurality of non-linear fins extends in a longitudinal direction of the housing. The plurality of non-linear fins are arranged along a transverse direction of the housing. Adjacent two of the plurality of non-linear fins together form a flow channel. Adjacent two of the plurality of non-linear fins are substantially linearly symmetrical about a longitudinal axis of the housing.

According to another embodiment of the present disclosure, an optical module includes a housing and a heat sink. The heat sink located on an outer surface of the housing. The heat sink includes a plurality of non-linear fins. Adjacent two of the plurality of non-linear fins together form a flow channel. Each of the plurality of non-linear fins includes a plurality of linear parts and a plurality of non-linear parts. The plurality of non-linear parts together form a plurality of wide segments of the flow channel. The plurality of linear parts together form a plurality of narrow segments of the flow channel. The plurality of linear parts of each of the plurality of non-linear fins include a first end linear part and a plurality of intermediate linear parts. The plurality of intermediate linear parts and the plurality of non-linear parts are arranged alternately. A length of the first end linear part is larger than a length of each of the plurality of intermediate linear parts.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a block diagram of an optical module according to an embodiment of the present disclosure;

FIG. 2 is a block diagram of an optical module according to another embodiment of the present disclosure;

FIG. 3 is a perspective view of an optical module according to another embodiment of the present disclosure;

FIG. 4 is a top view of the optical module in FIG. 3;

FIG. 5 is a partially enlarged view of the optical module in FIG. 4;

FIG. 6 is a cross-sectional view of the optical module in FIG. 3;

FIG. 7 is a top view of an optical module according to another embodiment of the present disclosure; and

FIG. 8 is a top view of an optical module according to still another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The thermal management of an optical module mainly relates to transferring the heat generated by components to a housing to dissipate the heat to the outside. The power consumption of the optical module is increased with the demand for high-speed optical communications, requiring higher heat dissipation efficiency. Disposing or forming heat dissipation fins on a housing of an optical module is one of the solutions to enhance heat dissipation efficiency. However, the existing heat dissipation fins are flat fins that extend linearly, whose heat dissipation capacity is unable to meet the demand for higher heat dissipation efficiency.

According to an embodiment of the present disclosure, when a working fluid, such as cold air, flows from an optical port end of the optical module to an electrical port end, a flowing velocity (the displacement of a fluid per unit time) of the working fluid flowing through the narrow segments may be increased, so that the working fluid flowing to the electrical port end has a higher flowing velocity. Compared with the existing flat heat dissipation fins, a flowing velocity of the working fluid flowing to the electrical port end may be increased by, but not limited to, about 50%. Besides, wide segments facilitate increase in contact area between the working fluid and the non-linear fins. Therefore, the flow channel formed by non-linear fins and including wide segments and narrow segments facilitate improving the heat dissipation capacity of the heat sink.

Some or all of the technical features disclosed in one or more embodiments of the present disclosure may be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the stated characteristic.

As used herein, “channel wavelengths” refer to the wavelengths associated with optical channels and may include a specified wavelength band around a center wavelength. More specifically, the channel wavelengths may be defined by an International Telecommunication (ITU) standard such as the ITU-T dense wavelength division multiplexing (DWDM) grid or coarse wavelength division multiplexing (CWDM). In one embodiment, the channel wavelengths are implemented in accordance with local area network (LAN) wavelength division multiplexing (WDM), which may also be referred to as LWDM.

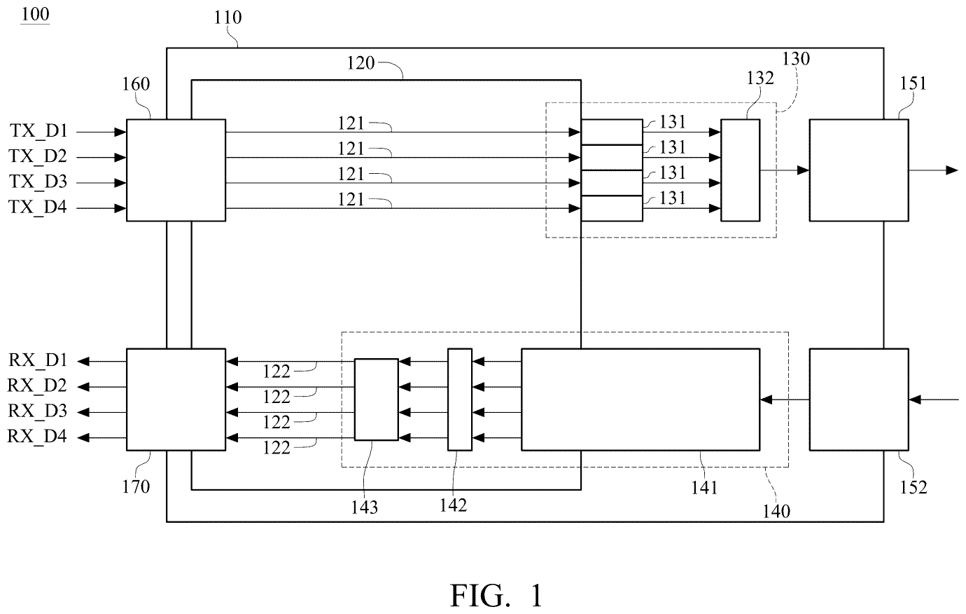

Please refer to FIG. 1. FIG. 1 is a block diagram of an optical module 100 according to an embodiment of the present disclosure. The optical module 100 may include a plurality of components disposed in the housing 110. Further, the optical module 100 may be understood as an optical transceiver or an optical subassembly, and the housing 110 may be understood as an hermetic housing or a non-hermetic housing. FIG. 1 exemplarily illustrates the optical module 100 that is an optical transceiver and may include a substrate 120 disposed in the housing 110. In addition, the optical module 100 may further include a transmitter optical subassembly (TOSA) 130 and a receiver optical subassembly (ROSA) 140 coupled to the substrate 120. In other embodiments where the optical module 100 is an optical subassembly, the optical module 100 may include one of the receiver optical subassembly and the transmitter optical subassembly.

The substrate 120 may be understood as a printed circuit board assembly (PCBA). One end of the substrate 120 may extend from the housing 110 to the outside, to realize the electrical interconnect between the optical module 100 and external circuits. The transmitter optical subassembly 130 and the receiver optical subassembly 140 may be configured to transmit and receive signals of multiple channel wavelengths, respectively. Specifically, the transmitter optical subassembly 130 may transmit optical signals of four different channel wavelengths, and the receiver optical subassembly 140 may receive optical signals of four different channel wavelengths (λ1, λ2, λ3, λ4).

The transmitter optical subassembly 130 may include an optical transferring unit 131 and a multiplexing unit 132. The optical transferring unit 131 may be understood as one or more laser diode(s). The multiplexing unit 132 may include an arrayed waveguide grating (AWG) or any component that is adapted to output multiple channel wavelengths after combining the same. The multiplexing unit 132 may be optically coupled to the optical transferring unit 131 to receive the optical signals transmitted by the optical transferring unit 131. The multiplexing unit 132 may further be optically coupled to the optical fiber connector 151. The optical fiber connector 151 may be understood as a LC connector. The transmitter optical subassembly 130 may further include passive optical components and/or active optical components. Each of the passive or active optical components may be, such as but not limited to, an optical isolator, an optical modulator, a focusing lens, or a monitor photodiode.

The receiver optical subassembly 140 may include a demultiplexing unit 141, an optical receiving unit 142, and an amplifier 143. The demultiplexing unit 141 may be understood as an arrayed waveguide grating, the optical receiving unit 142 may be understood as one or more photodiode(s), and the amplifier 143 may be understood as a transimpedance amplifier (TIA). The demultiplexing unit 141 may be optically coupled to the optical fiber connector 152. The optical fiber connector 152 may be understood as a LC connector. The demultiplexing unit 141 may be configured to divide the optical signals into multiple channel wavelengths and output the same to the optical receiving unit 142.

The optical module 100 may further include a transmit connecting circuit 160 (also called TX circuit) electrically connected to the transmitter optical subassembly 130 and a receiver connecting circuit 170 (also called RX circuit) electrically connected to the receiver optical subassembly 140. The transmit connecting circuit 160 may drive the optical transferring unit 131 of the transmitter optical subassembly 130. Further, the substrate 120 may have conductive wires 121 that electrically connect the transmit connecting circuit 160 and the optical transferring unit 131. The transmit connecting circuit 160 may receive driving signals (driving signals TX_D1 to TX_D4 as shown in FIG. 1) from the external circuits. The optical transferring unit 131 may transmit optical signals of certain channel wavelengths according to the driving signals. In addition, the substrate 120 may further have conductive wires 122 that electrically connect the receiver connecting circuit 170 and the amplifier 143. The optical receiving unit 142 may convert the optical signals into electrical signals, and output the electrical signals to the amplifier 143, so that the electrical signals may be amplified and/or modulated. Then, the electrical signals may output the electrical signals RX_D1 to RX_D4 as shown in FIG. 1 through the receiver connecting circuit 170.

Each of the transmit connecting circuit 160 and the receiver connecting circuit 170 may be understood as a gold finger of a printed circuit board. In some embodiments, the transmitter optical subassembly 130 or the receiver optical subassembly 140 may be encapsulated in a hermetic manner. In this embodiment, the transmit connecting circuit 160 or the receiver connecting circuit 170 may be understood as an electrical feedthrough. More specifically, the transmit connecting circuit 160 or the receiver connecting circuit 170 may be understood as a ceramic circuit board or a flexible circuit board.

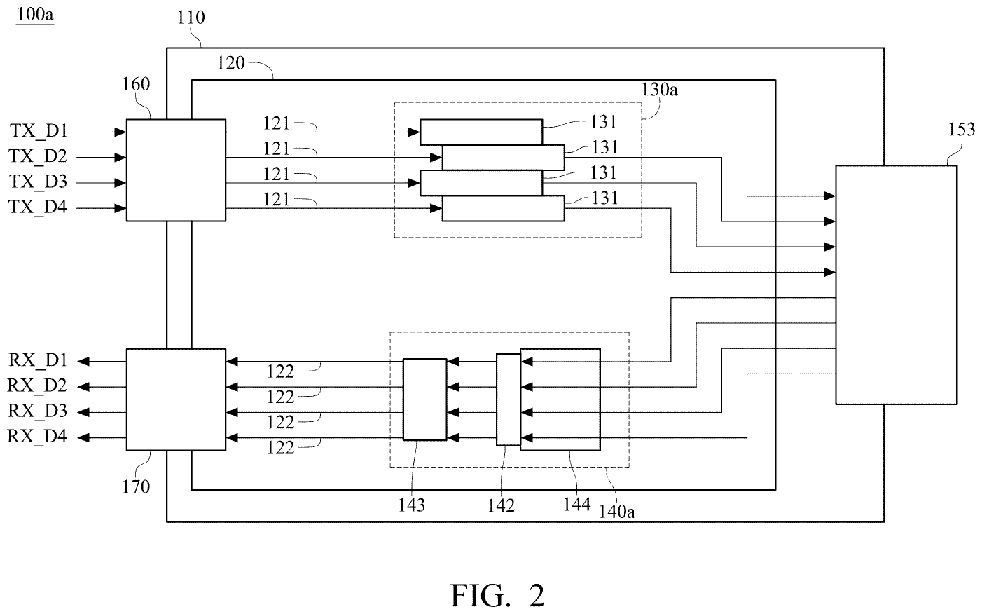

FIG. 2 is a block diagram of an optical module 100a according to another embodiment of the present disclosure. The optical module 100a and the optical module 100 have similar configurations. The difference between the optical module 100a and the optical module 100 is in that the optical module 100a may include a transmitter optical subassembly 130a without the multiplexing unit and a receiver optical subassembly 140a without the demultiplexing unit. Both of the transmitter optical subassembly 130a and the receiver optical subassembly 140a may be optically coupled to the optical fiber connector 153. The optical fiber connector 153 may be understood as a multi-fiber push on (MPO) connector or an active optical cable (AOC). In addition, the receiver optical subassembly 140a may include an optical fiber array 144 optically coupled to the optical fiber connector 153. The optical receiving unit 142 of the receiver optical subassembly 140a may receive optical signals through the optical fiber array 144.

FIGS. 1 and 2 exemplarily illustrate that the optical module transmits and receives the optical signals of four different channel wavelengths through the transmitter optical subassembly and the receiver optical subassembly, respectively, thereby realizing a signal transmission rate of, for example, 400 G bps or higher. However, the number of the channel and the signal transmission rate are not intended to limit the present disclosure.

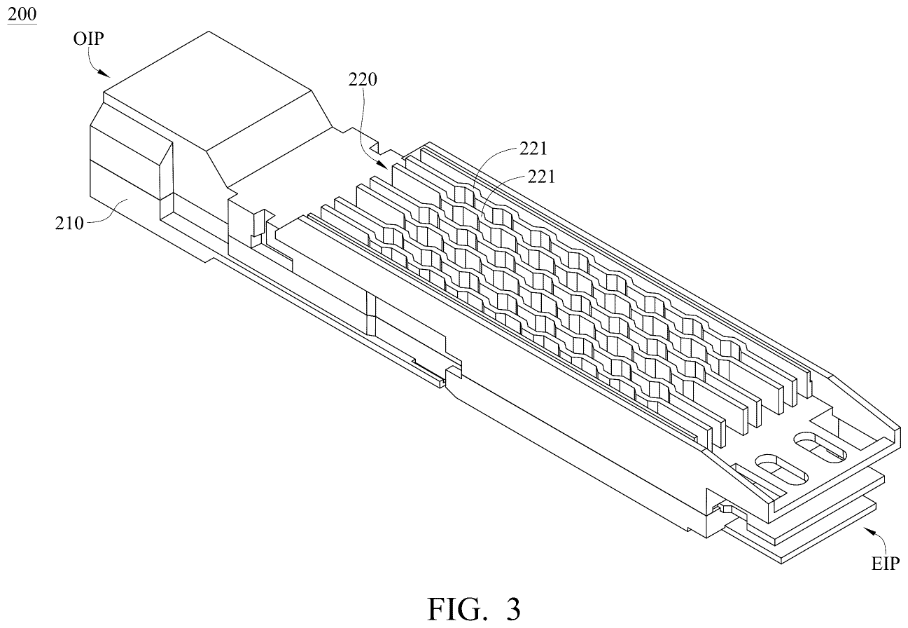

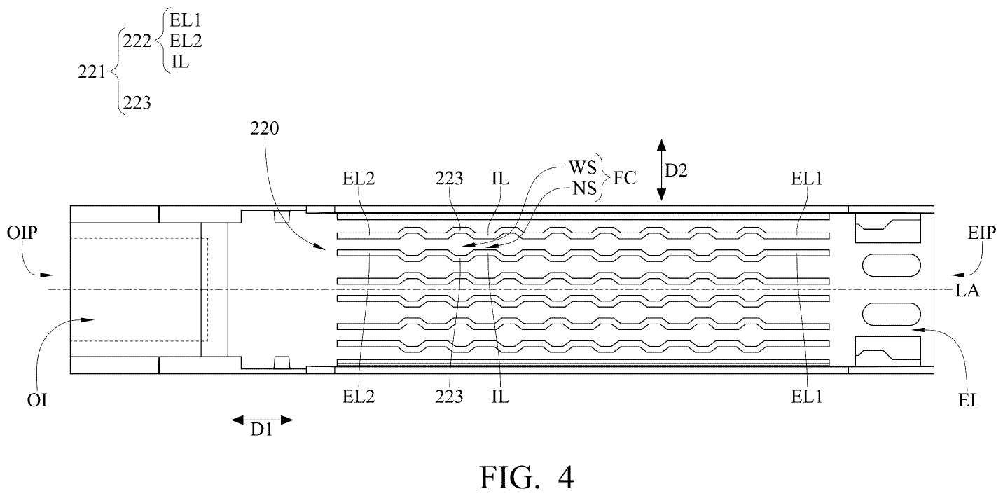

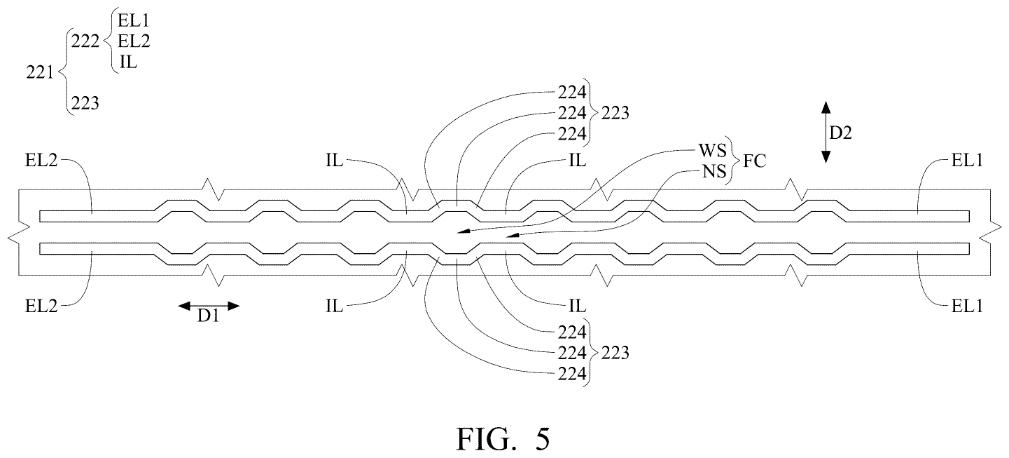

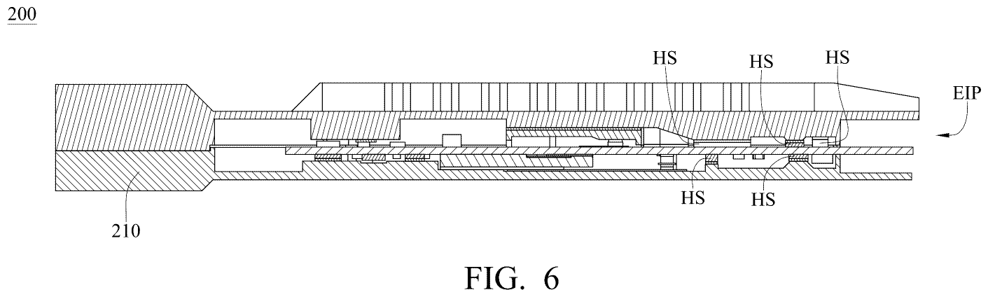

An optical module may include a heat sink. Please refer to FIGS. 3 to 6. FIG. 3 is a perspective view of an optical module 200 according to another embodiment of the present disclosure, FIG. 4 is a top view of the optical module 200 in FIG. 3, FIG. 5 is a partially enlarged view of the optical module 200 in FIG. 4, and FIG. 6 is a cross-sectional view of the optical module 200 in FIG. 3. In this embodiment, the optical module 200 may include a housing 210 and a heat sink 220.

The housing 210 may be a housing integrally formed as a single piece, or the housing 210 may be a multi-part housing including an upper housing part and a lower housing part. The housing 210 may be understood as the housing 110 in FIG. 1 or FIG. 2, and an outer surface of the housing 210 may be understood as an upper surface or a lower surface of the housing 210. The housing 210 may accommodate the substrate 120, the transmitter optical subassembly 130, and the receiver optical subassembly 140 as shown in FIG. 1 or FIG. 2.

The heat sink 220 may be located on the outer surface of the housing 210, and may include a plurality of non-linear fins 221. Each of the non-linear fins 221 may extend in a longitudinal direction D1 of the housing 210, and may be arranged along a transverse direction D2 of the housing 210. Based on the requirements of the specification (e.g., form factor or appearance improvement), a cover plate (not shown) may be located above and cover the non-linear fins 221.

Here, the term “non-linear fin” may denote a fin at least having a part that does not extend along the longitudinal direction D1 of the housing 210 (i.e., extends along a direction non-parallel to the longitudinal direction D1 of the housing 210). More specifically, each of the non-linear fins 221 may extend from an end portion of the housing 210 to another end portion thereof, where the said two end portions may have an optical port OI and an electrical port EI of the optical module 200, respectively. The optical port OI may be understood as the optical fiber connectors 151 and 152 in FIG. 1 or the optical fiber connector 153 in FIG. 2, and the electrical port EI may be understood as the transmit connecting circuit 160 or the receiver connecting circuit 170 in FIG. 1 or FIG. 2. The non-linear fins 221 may be fixed to the outer surface of the housing 210, or the housing 210 and the non-linear fins 221 may be integrally formed as a single piece.

In the transverse direction D2 of the housing 210, adjacent two non-linear fins 221 may together form a flow channel FC. Besides, the said adjacent two non-linear fins 221 may be substantially linearly symmetrical about a longitudinal axis LA of the housing 210. Further, each of the non-linear fins 221 may include a plurality of linear parts 222 and a plurality of non-linear parts 223. The linear parts 222 and the non-linear parts 223 may be connected to one another. For adjacent two non-linear fins 221, the linear parts 222 may be arranged symmetrically about the longitudinal axis LA, and the non-linear parts 223 may also be arranged symmetrically about the longitudinal axis LA.

The linear parts 222 and the non-linear parts 223 may be arranged alternately, to form a plurality of wide segments WS and a plurality of narrow segments NS of the flow channel FC. Further, for adjacent two non-linear fins 221, the non-linear parts 223 may together form wide segments WS, and the linear parts 222 may together form the narrow segments NS. FIGS. 4 and 5 exemplarily illustrate that the linear parts 222 extending along the longitudinal direction D1 of the housing 210 form straight narrow segment NS, and the non-linear parts 223 include linear segments 224 extending along different directions and connected to one another to form wide segments WS generally having a polygonal shape. However, the present disclosure is not limited thereto. In other embodiments, from a top view or a bottom view, the non-linear parts 223 may have a zigzag shape, an arc shape, or a wavy shape. FIG. 5 exemplarily illustrates that each of the non-linear parts 223 include three linear segments 224, with two linear segments 224 extending along a direction substantially intersecting the longitudinal axis LA and the other linear segment 224 extending along a direction substantially parallel to the longitudinal axis LA.

The linear parts 222 of each of the non-linear fins 221 may include a first end linear part EL1 and a plurality of intermediate linear parts IL. The intermediate linear parts IL and the non-linear parts 223 may be arranged alternately. Further, for adjacent two non-linear fins 221, the intermediate linear parts IL and the non-linear parts 223 may be arranged alternately, and the intermediate linear parts IL may together form the narrow segments NS of the flow channel FC. The first end linear part EL1 may be located closer to the electrical port EI of the optical module 200 than the intermediate linear parts IL.

The linear parts 222 of each of the non-linear fins 221 may further include a second end linear part EL2. The second end linear part EL2 may be located closer to the optical port OI of the optical module 200 than the intermediate linear parts IL and the first end linear part EL1. That is, the first end linear part EL1 and the second end linear part EL2 may be located adjacent to opposite ends of the optical module 200, respectively, and the intermediate linear parts IL and the non-linear parts 223 may be located between the first end linear part EL1 and the second end linear part EL2.

Please refer to FIGS. 4 and 5. When a working fluid, such as cold air, flows from an optical port end OIP of the optical module 200 to an electrical port end EIP, a flowing velocity (the displacement of a fluid per unit time) of the working fluid flowing through the narrow segments NS may be increased, so that the working fluid flowing to the electrical port end EIP has a higher flowing velocity. Compared with the existing flat heat dissipation fins, a flowing velocity of the working fluid flowing to the electrical port end EIP may be increased by, but not limited to, about 50%. Besides, wide segments WS increase the contact area between the working fluid and the non-linear fins 221. Therefore, the flow channel FC formed by non-linear fins 221 and including wide segments WS and narrow segments NS improves the heat dissipation capacity of the heat sink 220.

Without affecting the size of the optical module 200, the length of at least one of the first end linear part EL1 and the second end linear part EL2 may be increased as much as possible so that the flowing velocity of the working fluid may be maximized. In one embodiment, the optical module 200 may be designed to include longer first end linear part EL1. In one embodiment, the optical module 200 may be designed to include longer second end linear part EL2. In one embodiment, the optical module 200 may be designed to include both longer first end linear part EL1 and second end linear part EL2. Further, the length of the first end linear part EL1 may be larger than that of each of the intermediate linear parts IL, and the length of the second end linear part EL2 may be larger than that of each of the intermediate linear parts IL.

Please refer to FIG. 6. The first end linear part EL1 may be disposed to be corresponding to one or more active component(s) having high power consumption and being regarded as heat source(s) HS. In one embodiment, the first end linear part EL1 of each of the non-linear fins 221 may correspond to one or more heat sources selected from a group consisting of transimpedance amplifier (TIA), digital signal processor (DSP), laser diode (LD), laser driver (LDD) and a combination thereof. For example, in the embodiment of an Octal Small Form Factor Pluggable (OSFP) optical module, active components with high power consumption are located close to the electrical port of the optical module, causing the temperature of the electrical port to be significantly high. In this case, disposing the first end linear part EL1 to be located close to the electrical port end EIP allows the heat dissipation capacity of the heat sink 220 to be optimized.

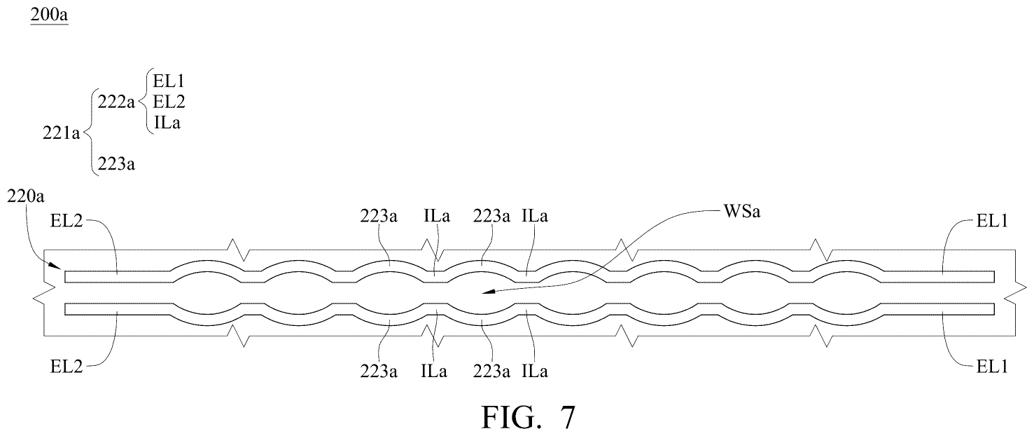

FIG. 7 is a top view of an optical module 200a according to another embodiment of the present disclosure. In this embodiment, a heat sink 220a of the optical module 200a may include non-linear fins 221a. The non-linear fins 221a may include linear parts 222a and non-linear parts 223a, and the linear parts 222a may include a first end linear part EL1, a second end linear part EL2, and an intermediate linear parts ILa. Each of the non-linear parts 223a of the non-linear fins 221a may generally be in an arc shape. FIG. 7 exemplarily illustrates non-linear parts 223a that are formed by arc lines, and the said non-linear parts 223a in an arc shape may have wide segments WSa that are generally in an oval shape.

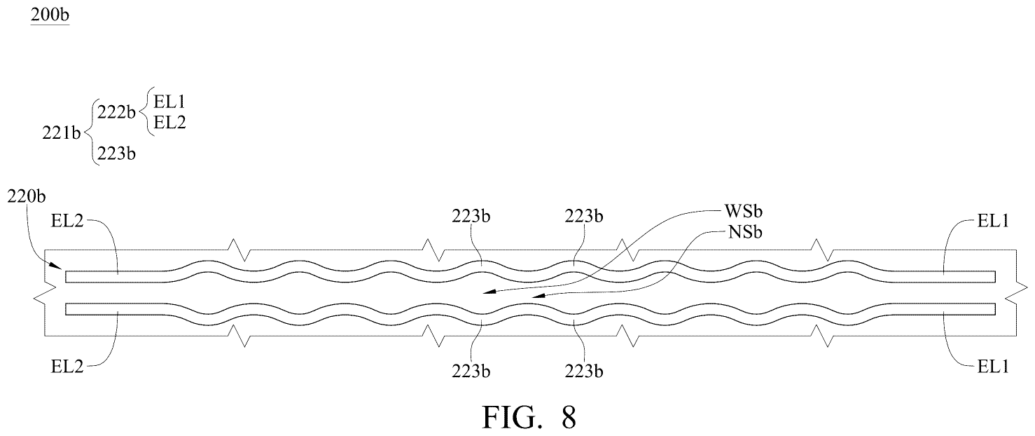

FIG. 8 is a top view of an optical module 200b according to still another embodiment of the present disclosure. In this embodiment, a heat sink 220b of the optical module 200b may include non-linear fins 221b. The non-linear fins 221b may include linear parts 222b and non-linear parts 223b. The non-linear fins 221b may only include end linear parts but do not include intermediate linear parts. To be more specific, the linear parts 222b of the non-linear fins 221b may only include a first end linear part EL1 and a second end linear part EL2. Further, the plurality of non-linear parts 223b of the non-linear fins 221b are directly connected to each other to form wide segments WSb that are generally circular and narrow segments NSb that are generally in an hourglass-shape.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical module, comprising:
a housing; and
a heat sink, located on an outer surface of the housing, wherein the heat sink comprises a plurality of non-linear fins, each of the plurality of non-linear fins extends in a longitudinal direction of the housing, and the plurality of non-linear fins are arranged along a transverse direction of the housing;
wherein, adjacent two of the plurality of non-linear fins together form a flow channel, and adjacent two of the plurality of non-linear fins are substantially linearly symmetrical about a longitudinal axis of the housing.

2. The optical module according to claim 1, wherein each of the plurality of non-linear fins comprises an end linear part and a plurality of non-linear parts, and the end linear part is located closer to an electrical port of the optical module than the plurality of non-linear parts.

3. The optical module according to claim 1, wherein the flow channel has a plurality of wide segments and a plurality of narrow segments which are arranged alternately.

4. The optical module according to claim 3, wherein each of the plurality of non-linear fins comprises a plurality of linear parts and a plurality of non-linear parts which are arranged alternately, the plurality of non-linear parts of adjacent two of the plurality of non-linear fins together form the plurality of wide segments, and the plurality of linear parts of adjacent two of the plurality of non-linear fins together form the plurality of narrow segments.

5. The optical module according to claim 4, wherein the plurality of linear parts of each of the plurality of non-linear fins comprise a first end linear part and a plurality of intermediate linear parts, the first end linear part is located closer to an electrical port of the optical module than the plurality of intermediate linear parts, the plurality of intermediate linear parts and the plurality of non-linear parts are arranged alternately, the plurality of intermediate linear parts of adjacent two of the plurality of non-linear fins together form the plurality of narrow segments, and a length of the first end linear part is larger than a length of each of the plurality of intermediate linear parts.

6. The optical module according to claim 5, wherein the plurality of linear parts of each of the plurality of non-linear fins further comprise a second end linear part, the second end linear part is located closer to an optical port of the optical module than the plurality of intermediate linear parts and the first end linear part, and a length of the second end linear part is larger than a length of the plurality of intermediate linear parts.

7. The optical module according to claim 5, wherein the first end linear part corresponds to a heat source selected from a group consisting of transimpedance amplifier, digital signal processor, laser diode, laser driver and combination thereof.

8. The optical module according to claim 4, wherein each of the plurality of non-linear parts is formed by a plurality of linear segments extending along different directions and being connected to each other.

9. The optical module according to claim 1, wherein the optical module is an Octal Small Form Factor Pluggable (OSFP) optical module.

10. An optical module, comprising:
a housing; and
a heat sink, located on an outer surface of the housing, wherein the heat sink comprises a plurality of non-linear fins, adjacent two of the plurality of non-linear fins together form a flow channel, each of the plurality of non-linear fins comprises a plurality of linear parts and a plurality of non-linear parts, the plurality of non-linear parts together form a plurality of wide segments of the flow channel, and the plurality of linear parts together form a plurality of narrow segments of the flow channel;
wherein, the plurality of linear parts of each of the plurality of non-linear fins comprise a first end linear part and a plurality of intermediate linear parts, the plurality of intermediate linear parts and the plurality of non-linear parts are arranged alternately, and a length of the first end linear part is larger than a length of each of the plurality of intermediate linear parts.

11. The optical module according to claim 10, wherein the first end linear part is located closer to an electrical port of the optical module than the plurality of intermediate linear parts.

12. The optical module according to claim 11, wherein the plurality of linear parts of each of the plurality of non-linear fins further comprise a second end linear part, the second end linear part is located closer to an optical port of the optical module than the plurality of intermediate linear parts and the first end linear part, and a length of the second end linear part is larger than a length of the plurality of intermediate linear parts.

13. The optical module according to claim 10, wherein each of the plurality of non-linear parts is formed by a plurality of linear segments extending along different directions and being connected to each other.

14. The optical module according to claim 10, wherein the first end linear part corresponds to a heat source selected from a group consisting of transimpedance amplifier, digital signal processor, laser diode, laser driver and combination thereof.

15. The optical module according to claim 10, wherein the optical module is an OSFP optical module.
